(19) United States
(12) Patent Application Publication
(10) Pub. No.: US 2025/0321087 A1
(43) Pub. Date: Oct. 16, 2025

(54) DIGITAL THREADED PLUG GAUGE

(71) Applicant: Levi Kemerling, Monona, IA (US)

(72) Inventor: Levi Kemerling, Monona, IA (US)

(21) Appl. No.: 19/013,485

(22) Filed: Jan. 8, 2025

Related U.S. Application Data
(60) Provisional application No. 63/633,731, filed on Apr. 13, 2024.

(51) Int. Cl. G01B 3/48

(52) U.S. Cl. CPC G01B 3/48

(57) ABSTRACT

A digital threaded plug gauge, including a barrel, a sleeve disposed around the barrel configured to move up and down with respect to the barrel, the sleeve including a serrated rod having serrations thereupon, a spring attached to the serrated rod to allow for elastic functionality of the serrated rod as the sleeve moves up and down with respect to the barrel, and a sprocket disposed within the sleeve to cause the serrations of the serrated rod to catch upon the sprocket to allow the digital threaded plug gauge to obtain a depth reading corresponding to a distance that the sleeve has traveled, a display unit to display a distance that the sleeve has traveled, and a caliper circuit board to sense a distance that the sleeve has traveled with respect to the barrel, thereby allowing the display unit to display the distance that the sleeve has traveled.

### CROSS-REFERENCE TO RELATED APPLICATIONS

This application claims priority under 35 USC § 120 from U.S. Provisional Application No. 63/633,731, entitled “DIGITAL THREADED PLUG GAUGE,” which was filed on Apr. 13, 2024, in the United States Patent and Trademark Office, the disclosure of which is incorporated herein in its entirety by reference.

### BACKGROUND

### 1. Field

The present general inventive concept relates generally to a gauge, and particularly, to a digital threaded plug gauge.

### 2. Description of the Related Art

Traditional methods of thread depth measurement often involve the use of multiple tools, making the process cumbersome and time consuming for professionals.

Considering how precision is paramount in the manufacturing industry, the necessity for varied tools makes active recordings prone to errors which can be costly during production.

Therefore, there is a need for a primary thread depth measurement accessory that is fully digital to enhance efficiency and significantly reduce the likelihood of error.

There is also a need for a gauge that is easy to handle and operate, allowing users to obtain precise thread depth measurements effortlessly, optimizing productivity, while reducing a user's learning curve.

### SUMMARY

The present general inventive concept provides a digital threaded pluggauge.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a digital threaded plug gauge, including a barrel having a cylindrical shape, a sleeve having a cylindrical shape and disposed around the barrel and configured to move up and down with respect to the barrel, the sleeve including a serrated rod having serrations thereupon, a spring attached to the serrated rod to allow for elastic functionality of the serrated rod as the sleeve moves up and down with respect to the barrel, and a sprocket disposed within the sleeve to cause the serrations of the serrated rod to catch upon the sprocket to allow the digital threaded plug gauge to obtain a depth reading corresponding to a distance that the sleeve has traveled with respect to the barrel, a display unit to display a distance that the sleeve has traveled, and a caliper circuit board to sense a distance that the sleeve has traveled with respect to the barrel, thereby allowing the display unit to display the distance that the sleeve has traveled.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a digital threaded plug gauge, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example e embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Digital Threaded Plug Gauge 100
Barrel 110
Sleeve 120
Serrated Rod 121
Spring 122
Sprocket 123
Calibration Shaft 130
Caliper Circuit Board 140
Display Unit 150
Threading 160
Battery Cap 170
Battery 171

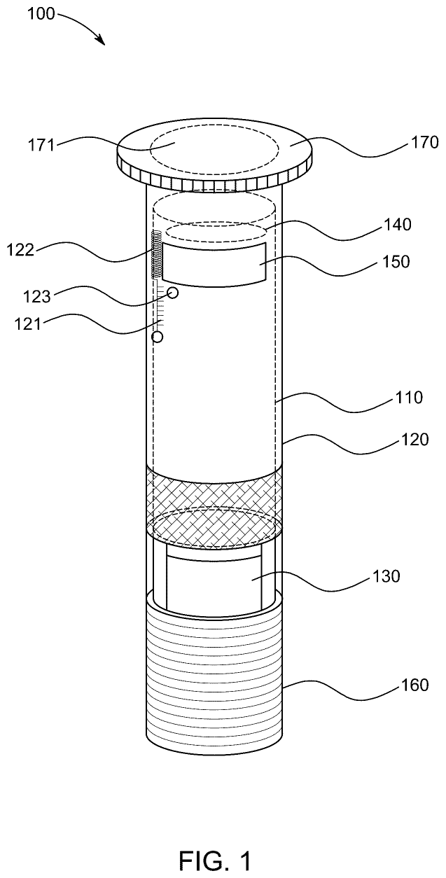

FIG. 1 illustrates a digital threaded plug gauge 100, according to an exemplary embodiment of the present general inventive concept.

The ergonomic crochet hook assembly 100, and all components therein and/or connected thereto, may be constructed from at least one of metal, plastic, wood, silicone, cloth, spandex, thread, and rubber, etc., but is not limited thereto, and can be constructed from any material known to one of ordinary skill in the art.

The digital threaded plug gauge 100 may include a barrel 110, a sleeve 120, a calibration shaft 130, a caliper circuit board 140, a display unit 150, a threading 160, and battery cap 170, but is not limited thereto.

The sleeve 120 may include a serrated rod 121, a spring 122, and a sprocket 123, but is not limited thereto.

The serrated rod 121 may have serrations (i.e., notches) that catch on the sprocket 123 at various points in order to allow the digital threaded plug gauge 100 to obtain a depth reading. The spring 122 may be attached to the serrated rod 121 to allow for elastic (e.g., springing) functionality of the serrated rod 121 as the sleeve 120 moves up and down within the barrel 110 when the user desires to obtain a depth measurement.

The display unit 150 may be connected to the caliper circuit board 140, such that when the caliper circuit board 140 senses a distance that the sleeve 120 has traveled within the barrel 110 during a measurement taking activity, the display unit 150 may display the distance that the sleeve 120 has traveled.

The threading 160 may correspond to a female threading of an object or a machine.

The battery cap 170 may cover a battery 171 that is connected to electronic components within the digital threaded plug gauge 100, such as the caliper circuit board 140 and the display unit 150.

The barrel may be bulky depending on how many accessories are included, such as a digital reading output display unit, a red to green light indicator, and an analog readout disposed on sleeve.

The threading is around every machine. Shop pressed into manual threaded plug gauges that should be replaced into the gauge, pressed and calibrated to the sleeve into the barrel.

Sleeve works against a digital indicator with desired travel, placed in a barrel. The sleeve will rotate and be free moving, similar to an analog threaded plug gauge. On top of the sleeve will be a flat washer for a roller to skate on. Attached to the roller is a rod similar to a depth rod on a conventional caliper.

The serrated rod has a travel distance of a predetermined length. The serrated edge of the rod coincides with the sprocket attached to a caliper circuit board.

The present general inventive concept may include a digital threaded plug gauge 100, including a barrel 110 having a cylindrical shape, a sleeve 120 having a cylindrical shape and disposed around the barrel 100 and configured to move up and down with respect to the barrel 110, the sleeve 120 including a serrated rod 121 having serrations thereupon, a spring 122 attached to the serrated rod 121 to allow for elastic functionality of the serrated rod 121 as the sleeve 120 moves up and down with respect to the barrel 110, and a sprocket 123 disposed within the sleeve 120 to cause the serrations of the serrated rod 121 to catch upon the sprocket 120 to allow the digital threaded plug gauge 100 to obtain a depth reading corresponding to a distance that the sleeve 120 has traveled with respect to the barrel 110, a display unit 150 to display a distance that the sleeve 120 has traveled, and a caliper circuit board 140 to sense a distance that the sleeve 120 has traveled with respect to the barrel 110, thereby allowing the display unit 150 to display the distance that the sleeve 120 has traveled.

A main purpose of the present general inventive concept is to provide users with a digital threaded plug gauge that revolutionizes accuracy in manufacturing. Ingenious and practical, the present general inventive concept offers a modern accessory that streamlines the measurement process, providing a one-stop solution that saves time and enhances accuracy, allowing for precise size recordings. The present general inventive concept introduces a novel tool that combines an internal to external sleeve positioned against a caliper depth rod, and an integrated circuit board, which together makes the tool effective in providing swift and accurate measurements without the need for additional devices. The present general inventive concept utilizes a spring-loaded sleeve, which is pressed against a caliper depth rod so as the gauge is threaded into a tapped hole, the sleeve moves into the device, pushing a serrated internal rod that rotates the circuit board gear, much like a caliper. This seamless mechanism guarantees precise and reliable thread depth measurements, significantly reducing the likelihood of errors in the manufacturing process. By eliminating the need for multiple tools and providing accurate measurements with a single device, the present general inventive concept saves valuable time and reduces expenses associated with purchasing and maintaining various measuring instruments; thus, it may prove to be essential in the hardware/tools industry.

The present general inventive concept includes a digital threaded plug gauge used to measure a depth of threaded holes without a need for extra tools to eliminate one of the most common errors in the manufacturing field of finding thread depth accurately. The present general inventive concepts functions like a conventional threaded plug gauge, but includes an internal to external sleeve pressed against a caliper depth rod and circuit board built into the device, such that the sleeve may be pushed against an internal spring down to the lead thread. When threaded into a tapped hole, the sleeve may move into the device, in turn pushing an internal serrated rod rotating the circuit board gear as a caliper would.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A digital threaded plug gauge, comprising:
a barrel having a cylindrical shape;
a sleeve having a cylindrical shape and disposed around the barrel configured to move up and down with respect to the barrel, the sleeve comprising:
a serrated rod having serrations thereupon,
a spring attached to the serrated rod to allow for elastic functionality of the serrated rod as the sleeve moves up and down with respect to the barrel, and
a sprocket disposed within the sleeve to cause the serrations of the serrated rod to catch upon the sprocket to allow the digital threaded plug gauge to obtain a depth reading corresponding to a distance that the sleeve has traveled with respect to the barrel;
a display unit to display a distance that the sleeve has traveled; and
a caliper circuit board to sense a distance that the sleeve has traveled with respect to the barrel, thereby allowing the display unit to display the distance that the sleeve has traveled.
